(19) United States
(12) Patent Application Publication
(10) Pub. No.: US 2025/0282040 A1
(43) Pub. Date: Sep. 11, 2025

(54) METHOD AND CONTROL DEVICE FOR DISPLAYING A MODEL OF AN OBJECT BEING PROCESSED BY A MANUALLY OPERATED TOOL

(71) Applicant: ATLAS COPCO INDUSTRIAL TECHNIQUE AB, Stockholm (SE)

(72) Inventor: Johan WALLGREN, Stockholm (SE)

(73) Assignee: ATLAS COPCO INDUSTRIAL TECHNIQUE AB, Stockholm (SE)

(21) Appl. No.: 18/860,785

(22) PCT Filed: Mar. 22, 2023
(86) PCT No.: PCT/EP2023/057288

§ 371 Date: Oct. 28, 2024

(30) Foreign Application Priority Data
May 10, 2022 (SE) 2230141-0

(51) Int. Cl. B25F 5/00; G05B 19/418

(52) U.S. Cl. CPC B25F 5/00; G05B 19/41805; G05B 19/41815; G05B 19/4183

(57) ABSTRACT

A method of controlling an operator display arranged to display a model of an object being processed by a manually operated tool is provided. The displayed model is part of an operator instruction of how to process the object using the tool. The method comprises determining a position of the tool in relation to the object; and, based on the determined position of the tool in relation to the object, automatically selecting a viewing direction of the model of the object to be displayed on the operator display. The operator may then not have to manually select a picture/viewing angle of the model. Instead, the selection is made automatically depending on where the operator holding the tool is located in relation to the object. Hence, usage of the operator instructions is facilitated for the operator and time consuming manual handing can be reduced.

### FIELD OF THE INVENTION

The present invention generally relates to the field of controlling display of operator instructions for manually operated tools.

### BACKGROUND OF THE INVENTION

In industrial factories, operator instructions are provided for instructing operators of how to process the objects being manufactured. The operator instructions may for example include a picture of the object to be processed together with instructions making it understandable for the operator how he/she should process the object. As an example, an operator instruction may depict a vehicle engine with signs/markings where joints should be tightened by means of a tool operated by the operator. Operator instructions may often comprise several pictures depicting the object from different points of view to visualize several processing steps making it cumbersome and time consuming for the operator to select the right picture.

### SUMMARY OF THE INVENTION

It would be advantageous to achieve a method and control device overcoming, or at least alleviating, the above mentioned drawback. In particular, it would be desirable to enable a method and control device facilitating for an operator the usage of operator instructions.

To better address one or more of these concerns, a method and control device having the features defined in the independent claims are provided. Preferable embodiments are defined in the dependent claims.

Hence, according to a first aspect, a method of controlling an operator display is provided. The operator display is arranged to display a model of an object being processed by a manually operated tool, the displayed model being part of an operator instruction of how to process the object using the tool. The method comprises: determining a position of the tool in relation to the object; and, based on the determined position of the tool in relation to the object, automatically selecting a viewing direction of the model of the object to be displayed on the operator display.

According to a second aspect, a control device for controlling an operator display is provided. The operator display is arranged to display a model of an object being processed by a manually operated tool, the displayed model being part of an operator instruction of how to process the object using the tool. The control device is configured to perform the method as defined in the first aspect.

By using information of the position of the tool in relation the object, an automatic selection of the viewing angle of the model of the object can be made. For example, if the operator holding the tool stands on a particular side of the object to be processed, the model displayed in the operator instruction may be displayed as seen from that particular side. The operator may then not have to manually select a picture/viewing angle of the model. Instead, the selection is made automatically depending on where the operator holding the tool is located in relation to the object. Hence, usage of the operator instructions is facilitated for the operator and time consuming manual handing can be reduced, which in the end leads to reduced manufacturing time and cost. Further, positioning means are often already provided in the tool for determining the position of a processing point (such as a joint) to be processed by the tool, whereby further hardware to the tool may not be necessary to add.

The operator instruction may alternatively be referred to as a work flow instruction, an operating sequence, work order, work task order or the like.

In the present specification, the term “manually operated tool” may include any tool at least partly operable by a human. It may include any tool movable by a human, optionally with the aid of some type of machinery. The tool may e.g. be entirely handheld, or manually operable by means of a torque reaction arm.

According to an embodiment, the viewing direction of the model of the object may be automatically selected such that a point of view on the model of the object to be displayed on the operator display reflects the determined position of the tool in relation to the object.

In this context, the term “reflects” may include (at least roughly) corresponds to. Hence, the point of view from which the model on the display is virtually viewed may essentially correspond to (or even equal) the determined position of the tool.

How closely the selected viewing direction reflects the actual position determined for the tool may vary in different embodiments.

According to an embodiment, the method may further comprise storing at least two pictures depicting said model from at least two different points of view. Automatically selecting the viewing direction of the model of the object to be displayed on the operator display may then comprise, based on the determined position of the tool in relation to the object, selecting one of said at least two pictures to be displayed on the operator display. The more pictures depicting the model from unique points of view that are provided, the more precise can the selected viewing direction of the model reflect the actual detected position of the tool. The present embodiment is advantageous in that it enables reduced storage space, as the pictures of the models that needs to be stored may simply be two dimensional images.

According to another embodiment, the method may further comprise storing a 3D (three dimensional) model of the object, wherein automatically selecting the viewing direction of the model of the object on the operator display may comprise rotating the 3D model based on the determined position of the tool in relation to the object, preferably such that the point of view of the 3D model reflects the determined position of the tool. Thus, the model of the object may be a 3D model. It may be possible to select a view that more closely reflects the actual detected position of the tool, as a (preferably stepless) rotation of the 3D model allows an (at least almost) infinite number of viewing points to be selected. The 3D model may e.g. be a CAD (Computer Aided Design) model or any other kind of 3D visualisation of the object.

According to an embodiment, the position of the tool in relation to the object may be determined by the same means as those used for determining a position of a processing point (such as a joint) to be processed (such as tightened) by the tool. Hence, no additional hardware for positioning of the tool need to be added to the tool/system.

For example, positioning of the tool may be detected with camera based techniques, such as cameras mounted in the roof above the processing area, and/or a camera mounted on the tool that recognizes images of the object, optionally including the use of tags (e.g. with QR code or other matrix code) on the tool and on the object detectable by the camera/cameras. Other techniques that may be envisaged are radio based techniques, such as UWB (Ultra Wide Band radio), wherein the time of flight (or similar) of radio signals between the tool and object is determined in order to calculate the position of the tool relative to the object. In case the tool is held by a torque reaction arm, the positioning may be made by detecting the angle of the joints in the arm. Other positioning techniques known in the art may also be envisaged.

According to an embodiment, the method may be performed in an industrial assembly factory, such as in an automotive assembly factory.

According to an embodiment, the tool may be a tightening tool. The processing of the object may include tightening of joints (fastening means), such as screws/bolts/nuts at the object.

According to an embodiment, a computer program is provided comprising instructions which, when the program is executed by a computer, cause the computer to carry out the method as defined in accordance with the first aspect or any one of the previously described embodiments.

According to an embodiment, a computer-readable storage medium is provided comprising instructions which, when executed by a computer, cause the computer to carry out the method as defined in accordance with the first aspect or any one of the previously described embodiments.

According to an embodiment, a system is provided comprising: a manually operable tool; an operator display arranged to display a model of an object being processed by the manually operable tool, the displayed model being part of an operator instruction of how to process the object using the tool, and a control device as defined in accordance with the second aspect.

It is noted that embodiments of the invention relates to all possible combinations of features recited in the claims. Further, it will be appreciated that the various embodiments described for the method are all combinable with the control device as defined in accordance with the second aspect of the present invention.

### BRIEF DESCRIPTION OF THE DRAWINGS

These and other aspects will now be described in more detail in the following illustrative and non-limiting detailed description of embodiments, with reference to the appended drawings.

FIG. 1 shows a system according to an embodiment.

FIG. 2A shows a display comprised in the system when an operator is positioned at A in FIG. 1.

FIG. 2B shows the display comprised in the system when an operator is positioned at B in FIG. 1.

FIG. 3 shows a method according to an embodiment.

All the figures are schematic, not necessarily to scale, and generally only show parts which are necessary in order to elucidate the embodiments, wherein other parts may be omitted. Like reference numerals refer to like elements throughout the description.

### DETAILED DESCRIPTION OF EMBODIMENTS

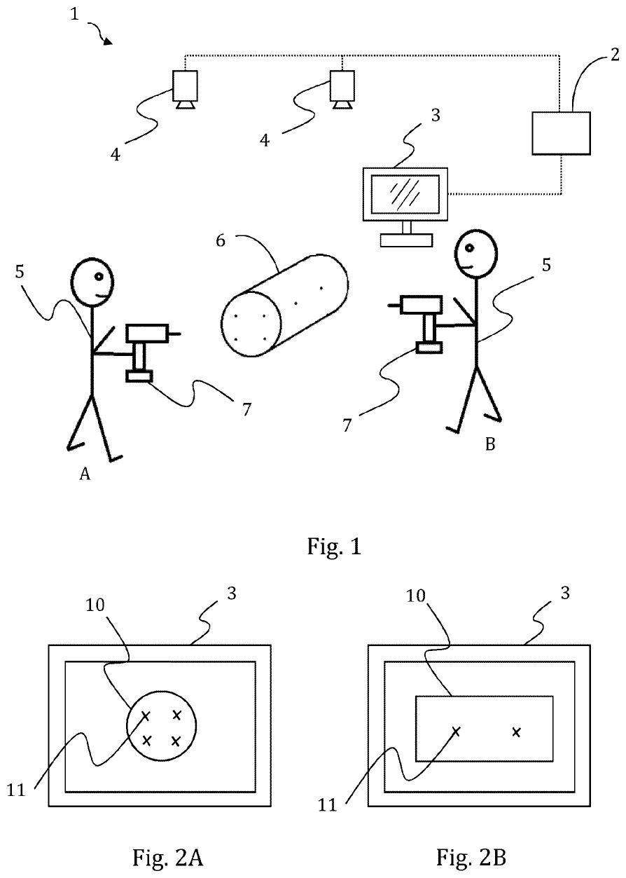

A system 1 according to an embodiment will be described with reference to FIG. 1. The system 1 comprises a tool 7 operable by an operator 5. The tool 5 may e.g. be a power tool, such as a tightening tool, drill, grinder or the like. The system 1 may be referred do as an industrial manufacturing system 1. The operator 5 uses the tool 7 to process an object 6. For illustrative purpose, and for the sake of simplicity, the object 6 in this example is depicted simply a solid cylinder. However, it will be appreciated that the object 6 to be processed by the operator 5 may be virtually any product being manufactured in an industrial factory, such as a vehicle part, a consumer product just to mention a few examples.

The system 1 further comprises an operator display 3 for the purpose of displaying an operator instruction for the operator 5. The operator instruction displayed on the display 3 comprises a model of the object 6 and preferably also sign/markings/text information helping the operator 5 to understand how to process the object 6.

The system 1 further comprises a control device 2 configured to control the display 3, and optionally also other parts of the system 1, such as the tool 7. The control device 2 may alternatively be referred to as a computer, control unit, control system or the like. The control device 2 may comprise and a memory and a processor for storing an executing computer program code. The control device 2 may be connected to the devices it controls by wire or wirelessly for sending (and optionally also receiving) data thereto (or therefrom).

The system 1 may further comprise means 4 for determining a position of the tool 7 in relation to the object 6. The means 4 for positing the tool 7 sends information to the control device 2 enabling the control device 2 to calculate/determine the position of the tool 7 in relation to the object 6. For example, the position of the tool 7 may be determined in one step, and the position of the object 6 may be determined in another step or may be predetermined (such as a pre-set fixed position). The interrelation between the tool 7 and the object 6 may then be determined.

The means 4 for determining the position of the tool 7 may be the same as those used for determining the position of the tool 7 for the purpose of determining the position of the processing points on the object 6. This is often made in industrial manufacturing in order to provide traceability on each processing point. For example, the control device 2 may be configured to save information, such as the used tightening torque and angle, and if the tightening was OK/NOK, together with positioning information of each processed joint.

For example, the system 1 may comprise one or more cameras 4 arranged in a roof above the processing area. The cameras 4 may send image data to the control device 2. From this image data, the control device 2 may be able to identify the tool 7 and the object 6 e.g. by identifying tags/markings placed on the tool 7 and the object 6 and to calculate the relative position of the tool 7 and the object 6. Any other suitable means for tool positioning known in the art may also be envisaged.

Operation of the system 1 will now be described with reference to FIGS. 1, 2A and 2B. When the operator 5 should start processing the object 6, the position of the tool 7 in relation to the object is determined by the control device 2, such as by analysis of image data from the cameras 4. According to a first example, the operator is positioned at position A (on the left hand side of FIG. 1), that is, at the short end of the cylinder formed object 6. The control device 2 then automatically selects a viewing direction of the model 10 of the object 6 and commands the display 3 to display the model 10 from that viewing direction, as illustrated in FIG. 2A. Hence, the operator 5 will see the short end of the modelled object 10 on the display 3. For example, the display 3 may also show markings 11 where joints should be tightened at the object 6 so the operator 5 knows how to process the object 6.

For example, the control device 2 may select, based on the determined position of the tool 7, one of at least two pictures of the model 10 that depicts the object 6 from a unique angle, such that the selected picture depicts the model 10 from a side that matches the point of view of the operator 5 holding the tool 7.

Alternatively, the control device 2 may store a 3D model 10 of the object 6, wherein the 3D model is rotated to a position based on the determined position of the tool 7, such that the point of view on the model 10 on the display reflects the determined position of the tool 7.

According to a second example, the operator 5 has moved to position B (on the right hand side of FIG. 1), that is, at the long side of the cylinder formed object 6. The control device 2 then automatically selects a viewing direction of the model 10 of the object 6 and commands the display 3 to display the model 10 from that viewing direction, as illustrated in FIG. 2B. Hence, the operator 5 will see the long side of the modelled object 10 on the display 3. For example, the display 3 may also show markings 11 where joints should be tightened at the object 6 so the operator 5 knows how to process the object 6.

The determination of the position of the tool 7 and the automatic selection of viewing direction of the model 10 to be displayed may be performed repeatedly, such as on predetermined time intervals, or in response to some type of trigger signal, such as in response to that the operator 5 has finalized a particular processing step.

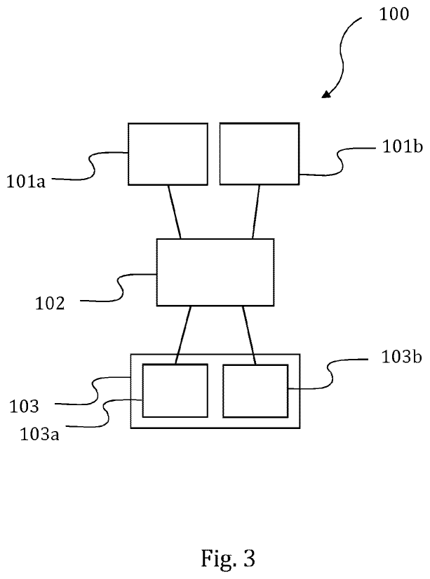

A method 100 of controlling an operator display (such as the display 3 of the system 1 described with reference to FIG. 1) according to an embodiment will be described with reference to FIG. 3. The method 100 may e.g. be performed by a control device (such as the control device 2 of the system 1 described with reference to FIG. 1) The method may comprise storing a model of the object to be processed, such as storing 101a at least two pictures depicting the model from at least two different points of view, and/or storing 101b a 3D model of the object. The method 100 further comprises determining 102 a position of the tool in relation to the object, and based on the determined position of the tool in relation to the object, automatically selecting 103 a viewing direction of the model of the object to be displayed on the operator display. Automatically selecting 103 the viewing direction of the model of the object to be displayed on the operator display may comprise, based on the determined position of the tool in relation to the object, selecting 103a one of the at least two pictures (stored in step 101a) to be displayed on the operator display. Alternatively (or as a complement), automatically selecting 103 the viewing direction of the model of the object on the operator display may comprises: rotating 103b the 3D model based on the determined position of the tool in relation to the object.

The person skilled in the art realizes that the present invention by no means is limited to the embodiments described above. On the contrary, many modifications and variations are possible within the scope of the appended claims.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage.

1. A method of controlling an operator display arranged to display a model of an object being processed by a manually operated tool, the displayed model being part of an operator instruction of how to process the object using the tool, the method comprising:
determining a position of the tool in relation to the object; and
based on the determined position of the tool in relation to the object, automatically selecting a viewing direction of the model of the object to be displayed on the operator display.

2. The method as defined in claim 1, wherein the viewing direction of the model of the object is automatically selected such that a point of view on the model of the object to be displayed on the operator display reflects the determined position of the tool in relation to the object.

3. The method as defined in claim 1, further comprising:
storing at least two pictures depicting said model from at least two different points of view, and
wherein automatically selecting the viewing direction of the model of the object to be displayed on the operator display comprises:
based on the determined position of the tool in relation to the object, selecting one of said at least two pictures to be displayed on the operator display.

4. The method as defined in claim 1, further comprising:
storing a 3D model of the object, and
wherein automatically selecting the viewing direction of the model of the object on the operator display comprises:
rotating the 3D model based on the determined position of the tool in relation to the object.

5. The method as defined in claim 1, wherein the position of the tool in relation to the object is determined by a same means present in the tool that is used for determining a position of a processing point to be processed.

6. The method as defined in claim 1, wherein the method is performed in an industrial assembly factory.

7. The method as defined in claim 1, wherein the tool is a tightening tool.

8. A control device for controlling an operator display arranged to display a model of an object being processed by a manually operated tool, the displayed model being part of an operator instruction of how to process the object using the tool, the control device configured to:
determine a position of the tool in relation to the object; and
based on the determined position of the tool in relation to the object, automatically selecting a viewing direction of the model of the object to be displayed on the operator display.

9. A computer program product stored on a non-transitory computer-readable medium, said computer program product for controlling an operator display arranged to display a model of an object being processed by a manually operated tool, the displayed model being part of an operator instruction of how to process the object using the tool, wherein said computer program product comprising computer instructions to cause one or more computing devices to perform the following operations:
determining a position of the tool in relation to the object; and
based on the determined position of the tool in relation to the object, automatically selecting a viewing direction of the model of the object to be displayed on the operator display.

10. (canceled)

11. A system comprising:
a manually operable tool;
an operator display arranged to display a model of an object being processed by the manually operable tool, the displayed model being part of an operator instruction of how to process the object using the tool; and
a control device configured to:
determine a position of the tool in relation to the object; and
based on the determined position of the tool in relation to the object, automatically selecting a viewing direction of the model of the object to be displayed on the operator display.

12. The control device as defined in claim 8, wherein the viewing direction of the model of the object is automatically selected such that a point of view on the model of the object to be displayed on the operator display reflects the determined position of the tool in relation to the object.

13. The control device as defined in claim 8, further configured to:
store at least two pictures depicting said model from at least two different points of view, and
wherein automatically selecting the viewing direction of the model of the object to be displayed on the operator display comprises:
based on the determined position of the tool in relation to the object, selecting one of said at least two pictures to be displayed on the operator display.

14. The control device as defined in claim 8, further configure to:
store a 3D model of the object, and
wherein automatically selecting the viewing direction of the model of the object on the operator display comprises:
rotating the 3D model based on the determined position of the tool in relation to the object.

15. The control device as defined in claim 8, wherein the position of the tool in relation to the object is determined by a same means present in the tool that is used for determining a position of a processing point to be processed.

16. The computer program product as defined in claim 9, wherein the viewing direction of the model of the object is automatically selected such that a point of view on the model of the object to be displayed on the operator display reflects the determined position of the tool in relation to the object.

17. The computer program product as defined in claim 9, further comprising computer instructions to cause one or more computing devices to perform the following operations:
storing at least two pictures depicting said model from at least two different points of view, and
wherein automatically selecting the viewing direction of the model of the object to be displayed on the operator display comprises:
based on the determined position of the tool in relation to the object, selecting one of said at least two pictures to be displayed on the operator display.

18. The computer program product as defined in claim 9, further comprising computer instructions to cause one or more computing devices to perform the following operations:
storing a 3D model of the object, and
wherein automatically selecting the viewing direction of the model of the object on the operator display comprises:
rotating the 3D model based on the determined position of the tool in relation to the object.

19. The computer program product as defined in claim 9, wherein the position of the tool in relation to the object is determined by a same means present in the tool that is used for determining a position of a processing point to be processed.
